(19) United States
(12) Patent Application Publication
(10) Pub. No.: US 2007/0204588 A1
(43) Pub. Date: Sep. 6, 2007

(54) Corn head trash cleaner

(75) Inventor: John D. Neece, Gardner, IL (US)

Correspondence Address: HARRY M. LEVY;OLSON & HIERL, LTD., 20 North Wacker, 36th Floor, CHICAGO, IL, 60606-4401, US

(73) Assignee: Shoup Manufacturing Co., Kankakee, IL (US)

(21) Appl. No.: 11/367,173

(22) Filed: Mar. 6, 2006

(51) Int. Cl. A01D 45/02

(52) U.S. Cl. 56/119

(57) ABSTRACT

A sweeper assembly for aiding a corn head for harvesting corn having a plurality of fingers or snoots extending forwardly of the associated combine and connected by a platform and a central aperture. A cross auger is mounted on the platform to move the corn ears away from the lateral portions of the corn head and a motor is connected to the sweeper to rotate downward and rearward of the sweeper to remove the debris.

### FIELD OF THE INVENTION

This invention relates to an improved method of harvesting corn and more specifically to an attachment apparatus to be used on combine and corn head combinations.

### BACKGROUND OF THE INVENTION

The inventive apparatus inhibits debris build-up on the corn head and the intake mechanism for the combine. By avoiding debris build-up, it aids the operator in avoiding the necessity in stopping the combine and turning off the power apparatus in order to clean the debris. The debris build-up can occur even in normal harvesting conditions and is much worse in dry conditions. Often, the operator will try to clear the debris by hand while the machine is still running in order to save time. This method of debris removal is exceptionally dangerous due to the moving machinery and rotating machinery which can grab loose clothing or catch hands, legs or feet.

Harvesting corn has become a very mechanized operation. The machinery includes a combine with an attached corn head. The corn head operates to cause the corn stalks to be moved into the combine where the corn and kernels are separated from the stalks and debris. The corn head attachment is comprised of corn head fingers or snoots that go between the rows of corn like a comb goes through hair. On the opposing surfaces of the fingers there are snapping rolls with protrusions that take the ears off the corn stalks and break them off from the root section. After the ears are freed from the corn stalk sections, the corn head moves the ears along with any other leaves or other debris that may be picked up from the stalks rearwardly using the gathering chains and the top of the stringer plates to an auger. The auger then moves the corn ears and associated debris to the center of the corn head, where the stalks and corn are transported rearward into the combine, where the corn and kernels are separated from the other material that has been harvested.

The corn head mechanism often becomes blocked by buildup of stalks, weeds or other debris that are picked up from the field and buildup either on top of the corn head or in front of the auger. Particularly in John Deere combines, there is a problem that in very dry harvesting conditions, chaff and other debris builds up in the center of the main auger and clogs the intake to the combine and can build up high enough to block the vision of the operator. In any event, the use of broom handles, sticks or the operator getting out of the combine and using their feet to dislodge this debris blockage is well known and a common source of injury and death. Safety concerns in addition to efficiency of operation dictate the need to provide an apparatus which allows the operator of the combine to continue operating in dry conditions without the heretofore identified problem.

### SUMMARY OF THE INVENTION

The present invention provides great improvement over corn harvesting machines and add-on apparatuses. One of the principal purposes of the present invention is to provide an operating apparatus which continually causes debris to be fed into the main or cross auger thereby allowing the operator to continue harvesting without the time consuming and inefficient down time encountered in the use of present day corn heads while at the same time ensuring the safety of the operator.

An important object of the invention is to provide a sweeper assembly apparatus for aiding a corn head for harvesting corn, comprising a corn head including a plurality of snoots extending forwardly of an associated combine and connected thereto by a platform having a central aperture therein through which corn ears pass into the associated combine, a cross auger having a longitudinally extending axis at the center line thereof, the cross auger being mounted on said platform for moving the corn ears from the lateral portions of the corn head toward the central aperture, a sweeper extending transversely of the combine with a longitudinally extending axis at the center line thereof generally parallel to and positioned in front of and above the cross auger longitudinally extending axis, a motor operatively connected to the sweeper for rotating the sweeper around its longitudinally extending axis causing debris if present above the cross auger to move downwardly and rearwardly into the cross auger.

Another object of the invention is to provide a device for harvesting corn, comprising a combine and a corn head including a plurality of snoots extending forwardly of the combine and connected thereto by a platform having a central aperture therein through which corn ears pass into the associated combine, a cross auger having a longitudinally extending axis at the center line thereof, the cross auger being mounted on the platform for moving the corn ears from the lateral portions of the corn head toward the central aperture and thereafter into the combine, an auxiliary auger extending transversely of the combine with a longitudinally extending axis at the center line thereof generally parallel to and positioned in front of and above the cross auger longitudinally extending axis, a motor operatively connected to the auxiliary auger for rotating the auxiliary auger around its longitudinally extending axis causing debris if present above the cross auger to move downwardly and rearwardly into the cross auger and thereafter into the combine.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is a perspective elevational view of a prior art combine with a corn head attached thereto;

FIG. 2 is an elevational view of a combine and corn head with the auxiliary auger of the present invention in the operating position;

FIG. 3 is a view like FIG. 2 with the auxiliary auger of the present invention in the upper maintenance position and with the snoot folded to permit maintenance thereon;

FIG. 4 is a sectional view of a portion of the auxiliary auger of the present invention showing motor mechanism therefor;

FIG. 5 is an elevational view like FIG. 4 of the opposite arm of the auxiliary auger mechanism of the present invention;

FIG. 6 is an elevational view of the auxiliary auger mechanism of the present invention in the down or working position showing the details of the motor and drive assembly; and

FIG. 7 is an elevational view of the auxiliary auger in the upper maintenance position showing the relationship of various parts thereof.

### DETAILED DESCRIPTION OF THE INVENTION

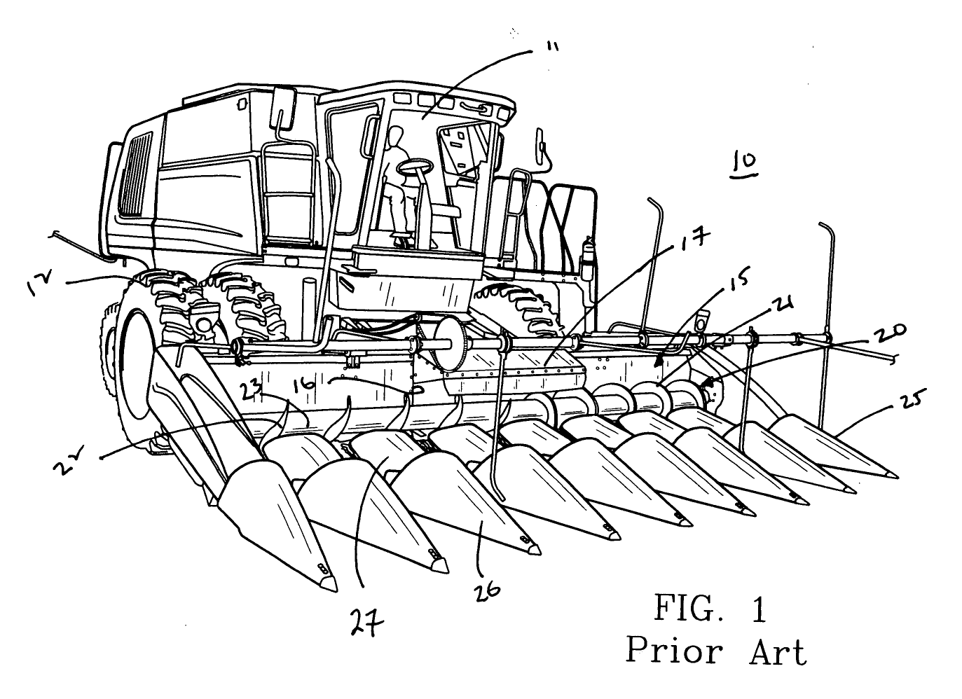

Referring to the prior art disclosed in FIG. 1 of the drawings, there is disclosed a combine 10 with a cab 11 provided with drive wheels 12.

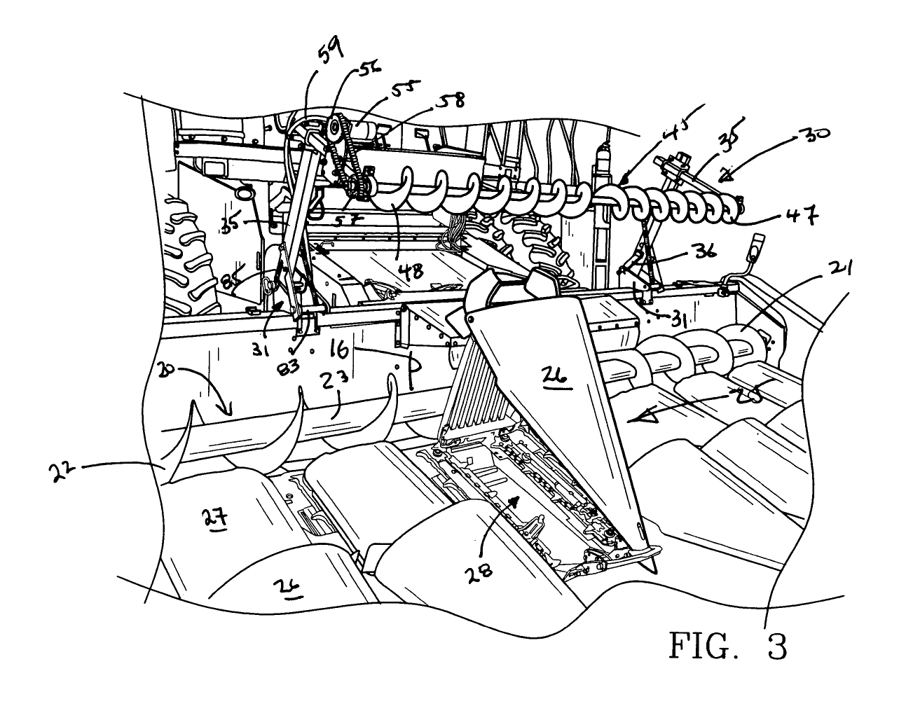

The combine 10 further includes a platform 15 having a central aperture 16 and a shield 17, the shield 17 being present as an add-on for John Deere combines. A cross or main auger 20 is rotatively positioned on the platform 15 and has flights 21 and 22 mounted on an axle 23 which extends transversely of the combine 10 and has a longitudinally extending center line. A plurality of fingers or snoots 25 are mounted to the platform 15 and extend forwardly thereof, the snoots 15 each having a portion 26 and a rear portion 27 which as shown in FIG. 1, are in the use or harvesting position. The snoots 25 may be pivoted to a maintenance position as shown in FIG. 3 wherein the pivotal mounting between the front and rear portions 26, 27 permits the snoots 25 to be moved into the maintenance position for access to the various mechanicals 28 such as snapping rolls, stripper plates and gathering chains, all as is well known in the art.

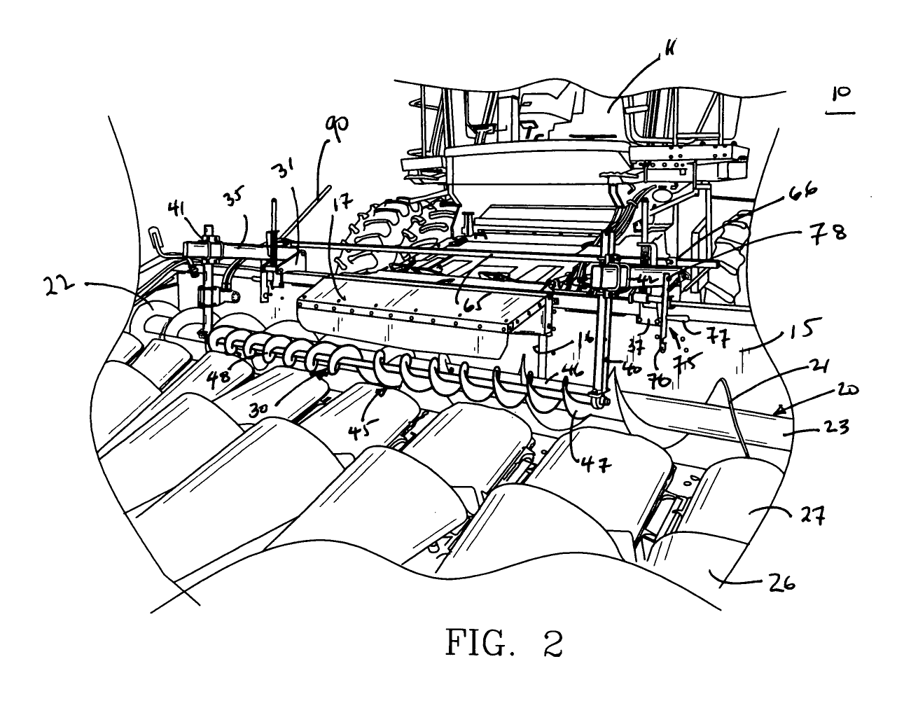

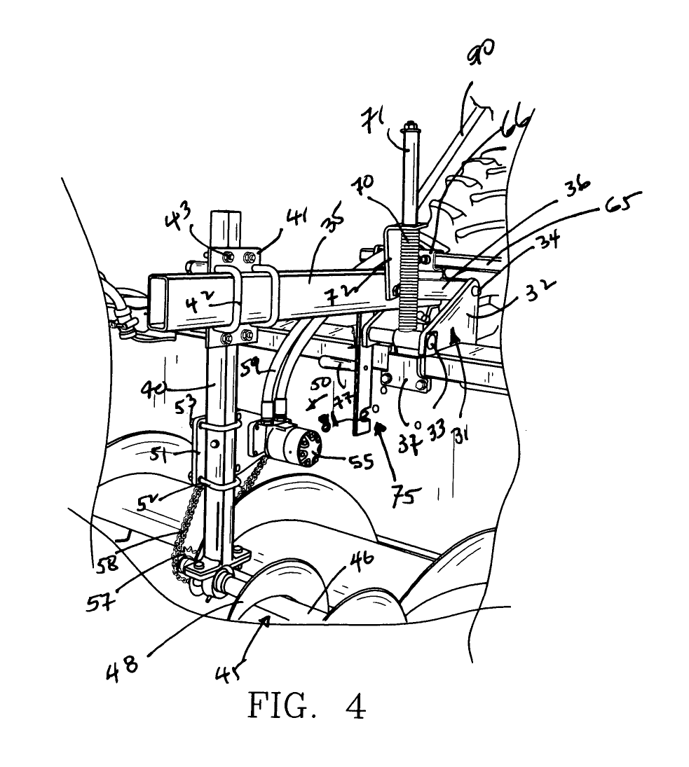

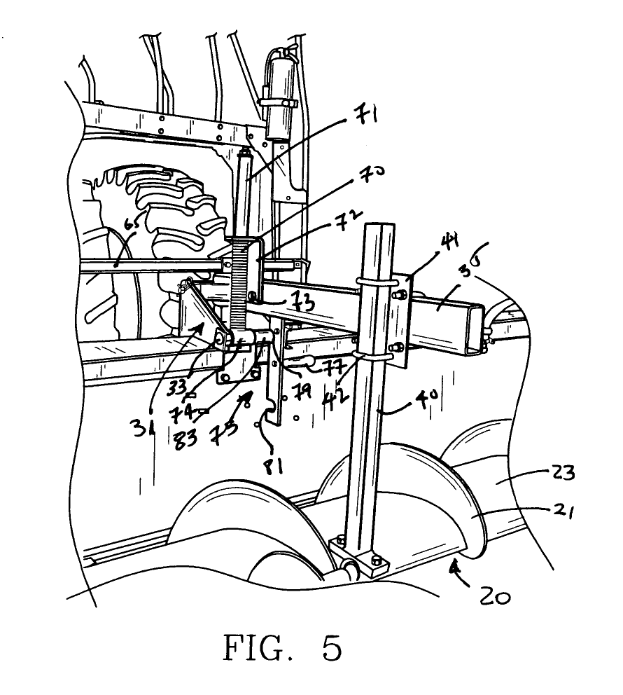

As shown particularly in FIGS. 2-7, an auxiliary auger assembly or sweeper 30 includes a pair of spaced apart mounting brackets 31 which as seen particularly in FIGS. 4 and 5, include spaced plates 32 interconnected by a rod 33 and a pivot pin 34. Each of the mounting brackets 31 has pivotally mounted thereto, a forwardly extending tubular arm 35 provided at the rear thereof with angularly extending braces 36. A mounting tab and bolts 37 extend downwardly from the mounting brackets 31 and serve to connect the mounting brackets with the platform 15.

Each of the arms 35 has a tubular standard 40 mounting generally perpendicularly thereto by means of a mounting bracket 41, U-caged bolts 42 and suitable fasteners 43. An auxiliary auger 45 is rotatably mounted between the standards 40 on an axle 46 having flights 47 and 48, the axle 46 having a center line which in use is parallel to, forward of and above the center line of the main axle 23 of the cross auger 20.

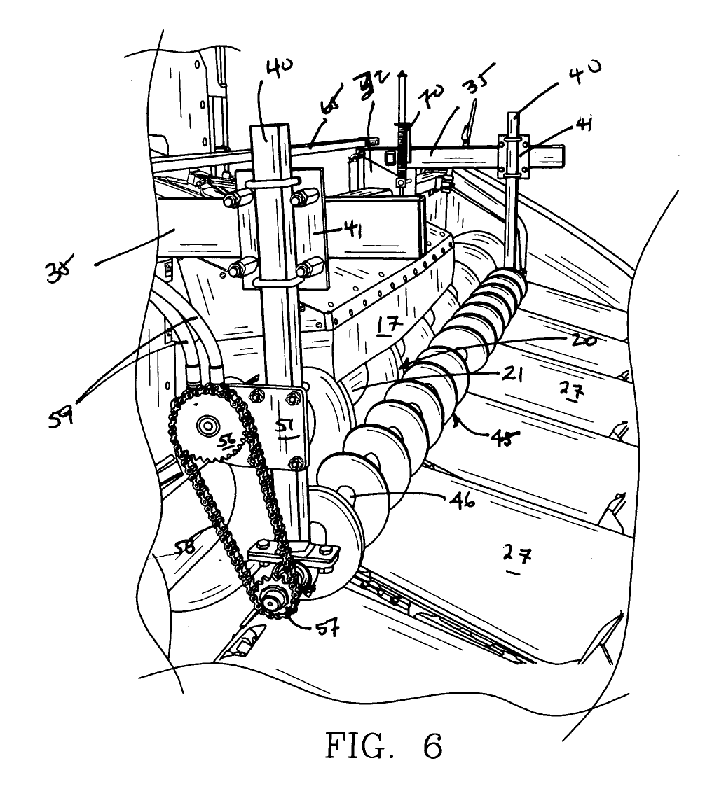

At least one of the standards 40 is provided with a motor assembly 50 which includes a motor mounting plate 51 sufficient u-caged bolts 52 and nuts 53 fixedly to mount a motor 55 to the plate 51. The motor 55 has a motor sprocket 56 mounted thereto, as best seen in FIGS. 4 and 6, with suitable bearings and the like, the sprocket 56 preferably, but not necessarily, having 14 teeth and connected to a sprocket 57, preferably having the same number of teeth as sprocket 56, at the end of the axle 46 by means of a chain 58. Hydraulic auxiliary hoses 59 connect the motor 55 to a source of hydraulic fluid, all as is well known in the art.

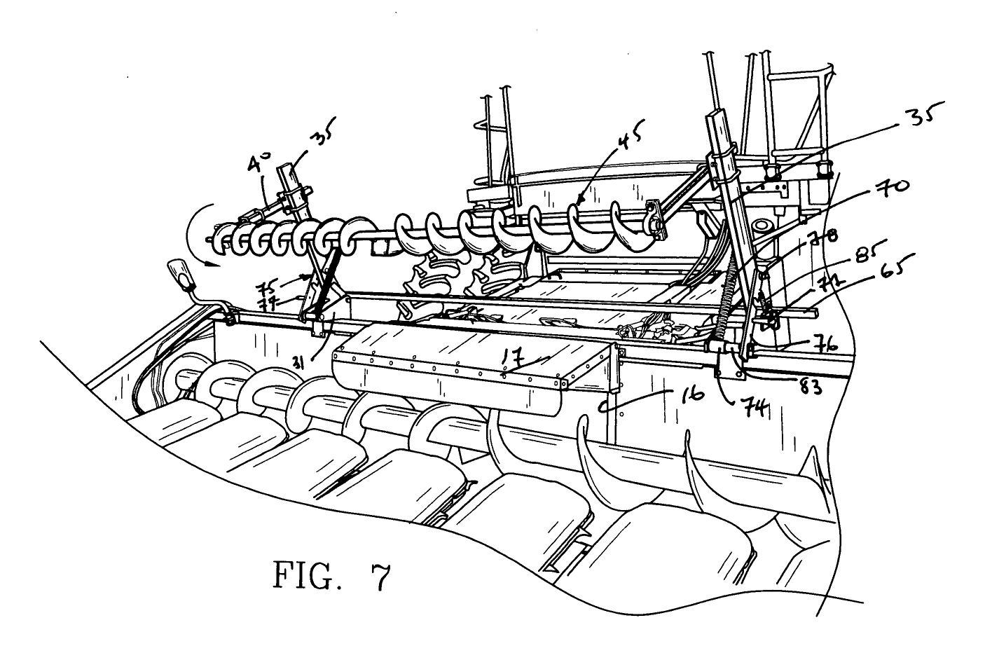

As seen in the drawings, an arm support tube 65 extends transversely of the combine 10 generally parallel to the auxiliary auger 45 and is mounted to the arms 35 by suitable fastening means 66. The auxiliary auger assembly or sweeper 30 is further provided with two springs 70, each mounted on the rod or pin 33 around a shaft or cylinder 71. The springs 70 are of the coil spring type and are trapped between an L-shaped bracket 72 which is fixedly mounted to the associated arm 35 by bolts 73 and a spring sleeve 74 which is mounted on a catch 83 which is an extension of the rod 33 for a purpose hereinafter set forth. A latch assembly 75 is provided on at least one and preferably both of the arms 35 and cooperates with the associated spring 70 so as to maintain the auxiliary auger 30 in either the maintenance or operative position. The auger latch assembly 75 includes an auger latch in the form of a bar 76 having a handle 77 extending therefrom, the latch being pivotally mounted as at 78 to the associated arm 35. Each auger latch 76 has an upper notch 79 and a lower notch 81, both of which are adapted to fit over the catch 84 which is an extension of the rod or pivot 33. Latch springs 85 are provided connecting the latch 76 to the platform 15 so as to bias the latch into the engaged position, as shown in FIGS. 2 and 7, particularly.

Finally, a wrench 90 is provided with fits over the end of the arm support tube 65 to provide a lever arm for moving the auxiliary auger 45 from the maintenance position shown in FIG. 7 to the operating position shown in FIG. 2. The wrench 90 is required since the springs 70 bias the auger 45 into the upper or maintenance position shown in FIG. 7.

In operation, the John Deere combine 10 is prone to excessive debris build-up over the shield 17 in dry conditions. This is particularly worrisome because it jams the combine intake and requires the operator to either stop the combine 10 and dismount in order to unclog the debris resulting, in as previously discussed, the possibility of injury and in any event, causing inefficiency in harvesting. In order to prevent the corn ears from kicking up out of the combine, John Deere provides the shield 17 as an option but installation of same also prevents trash and debris from being moved into the combine 10 thereby resulting in the aforementioned problems. As is well known, the main or cross auger 20 moves the harvested material from the lateral ends of the corn head toward the center and it is the purpose of the sweeper or auxiliary auger 45 to reduce the build-up of debris in dry conditions by cooperating with the main auger 20 and moving the debris downwardly and into the auger 20 for transmittal into the combine 10. This is accomplished by rotating the auxiliary auger 45 in the same direction as the main or cross auger 20 with the flights of the main auger being similar to the flights of the main auger 20. By positioning the longitudinal axis of the auxiliary auger 45 above and forward but parallel to the center line of the main auger 20, the build-up of materials above the shield 17 is prevented and ameliorated by the operation of the auxiliary auger 45 which moves the material as it builds up downwardly and rearwardly into the opening 16 and the combine 10.

The auxiliary auger assembly 30 is operated continuously while the combine 10 is operating, preventing excessive build-up of trash and clogging heretofore encountered. The auxiliary auger assembly 30 is positioned to move trash downwardly and rearwardly with respect to the combine 10 and cross auger 20, thereby continuously feeding material to the cross auger for transport into the combine through the opening 16. The only time the combine operator is required to dismount is for normal operation. Maintenance of the snoots 25 or other portions of the corn head is facilitated by positioning the assembly 30 in the maintenance position by operation of the latch assembly 75 with the assistance of the wrench 90, which is also used to move the auxiliary auger 45 into the operative position from the spring biased maintenance position.

While the invention has been particularly shown and described with reference to a preferred embodiment hereof, it will be understood by those skilled in the art that several changes in form and detail may be made without departing from the spirit and scope of the invention.

We claim:

1. A sweeper assembly apparatus for aiding a corn head for harvesting corn, comprising
a corn head including a plurality of snoots extending forwardly of an associated combine and connected thereto by a platform having a central aperture therein through which corn ears pass into the associated combine,
a cross auger having a longitudinally extending axis at the center line thereof,
said cross auger being mounted on said platform for moving the corn ears from the lateral portions of said corn head toward the central aperture,
a sweeper extending transversely of said combine with a longitudinally extending axis at the center line thereof generally parallel to and positioned in front of and above said cross auger longitudinally extending axis,
a motor operatively connected to said sweeper for rotating said sweeper around its longitudinally extending axis causing debris if present above said cross auger to move downwardly and rearwardly into said cross auger.

2. The sweeper assembly apparatus of claim 1, wherein said sweeper is an auger.

3. The sweeper assembly apparatus of claim 1, wherein said cross auger rotates to move corn ears through the aperture into the associated combine and said motor is adapted to rotate said sweeper in the same direction as said cross auger.

4. The sweeper assembly apparatus of claim 3, wherein said cross auger and said sweeper when rotated in the same direction move material from the lateral portions of said corn head toward the central aperture.

5. The sweeper assembly apparatus of claim 1, wherein said motor rotates said sweeper independently of said cross auger.

6. The sweeper assembly apparatus of claim 1, wherein said sweeper is movable between a maintenance position and a work position,
said work position being lower and forward of said maintenance position.

7. The sweeper assembly apparatus of claim 6, wherein said sweeper pivots between said work and maintenance positions.

8. The sweeper assembly apparatus of claim 7, wherein said sweeper is biased toward the maintenance position thereof.

9. A device for harvesting corn, comprising
a combine and a corn head including a plurality of snoots extending forwardly of said combine and connected thereto by a platform having a central aperture therein through which corn ears pass into the associated combine,
a cross auger having a longitudinally extending axis at the center line thereof,
said cross auger being mounted on said platform for moving the corn ears from the lateral portions of said corn head toward the central aperture and thereafter into said combine,
an auxiliary auger extending transversely of said combine with a longitudinally extending axis at the center line thereof generally parallel to and positioned in front of and above said cross auger longitudinally extending axis,
a motor operatively connected to said auxiliary auger for rotating said auxiliary auger around its longitudinally extending axis causing debris if present above said cross auger to move downwardly and rearwardly into said cross auger and thereafter into said combine.

10. The device of claim 9, wherein said motor rotates said auxiliary auger independently of said cross auger.

11. The device of claim 9, wherein said auxiliary auger is movable between a maintenance position and a work position,
said work position being lower and forward of said maintenance position.

12. The device of claim 11, wherein said auxiliary auger pivots between said work and maintenance positions.

13. The device of claim 12, wherein said auxiliary auger is biased toward the maintenance position thereof.
